(19) United States
(12) Patent Application Publication
(10) Pub. No.: US 2020/0303835 A1
(43) Pub. Date: Sep. 24, 2020

(54) Antenna Apparatus And Communications Apparatus

(71) Applicant: HUAWEI TECHNOLOGIES CO., LTD., Shenzhen (CN)

(72) Inventors: Wei XIONG, Shenzhen (CN); Bo XIE, Dongguan (CN); Zhulin CHENG, Dongguan (CN); Qiang HE, Shenzhen (CN); Yongjiu LI, Chengdu (CN)

(21) Appl. No.: 16/898,007

(22) Filed: Jun. 10, 2020

Related U.S. Application Data
(63) Continuation of application No. PCT/CN2018/120141, filed on Dec. 10, 2018.

(30) Foreign Application Priority Data
Dec. 11, 2017 (CN) 201711311229.7

(51) Int. Cl. H01Q 21/24; H01Q 19/18

(52) U.S. Cl. CPC H01Q 21/24; H01Q 19/18

(57) ABSTRACT

An antenna apparatus includes: N antenna ports and M directional polarization antennas, where M is K times 4, N is an integer multiple of 4, N and M are integers greater than 0, and K is an even number greater than 0; the M directional polarization antennas are evenly distributed on four surfaces of a cube, each surface includes K directional polarization antennas, a polarization direction of K/2 directional polarization antennas on each surface is a first polarization direction, and a polarization direction of other K/2 directional polarization antennas on each surface is a second polarization direction; and on two neighboring surfaces or two opposing surfaces of the four surfaces, K directional polarization antennas in a same polarization direction are combined into one channel, and are connected to one of the N antenna ports, and each of the N antenna ports is connected to the K directional polarization antennas.

### CROSS-REFERENCE TO RELATED APPLICATIONS

This application is a continuation of International Patent Application No. PCT/CN2018/120141, filed on Dec. 10, 2018, which claims priority to Chinese Patent Application 201711311229.7, filed on Dec. 11, 2017. The disclosures of the aforementioned applications are hereby incorporated by reference in their entireties.

### TECHNICAL FIELD

This application relates to the field of antenna technologies, and in particular, to an antenna apparatus and a communications apparatus.

### BACKGROUND

With development of internet services, people have an increasingly high requirement for broadband internet access. In some places, because it is inconvenient to deploy cables (optical fibers, copper cables, and the like) or deployment costs are relatively high, many operators use wireless broadband technologies to resolve a problem of internet access of users. In some rural and remote areas, populations are relatively sparse. Therefore, usually, a distance between base stations deployed by operators in these areas is relatively large, and a customer premise equipment (Customer Premise Equipment, CPE) with a high-gain antenna is selected and deployed at a user's home, to ensure user experience in a wide coverage scenario.

An outdoor terminal needs to be aligned with a base station when being installed. Currently, a design with a directional antenna is commonly used to improve a gain, so that installation personnel need to have professional capabilities to align a main lobe of the directional antenna with the base station to achieve optimal performance. Therefore, if alignment is not required during installation, usually a CPE uses a design with an omnidirectional antenna. However, a gain of the omnidirectional antenna is relatively low, leading to reduction of antenna performance. If an outdoor terminal uses a rotatable directional antenna, a built-in motor is needed to drive the antenna to rotate to an optimal direction. Because of existence of the built-in motor, a size of the outdoor terminal is increased. This makes installation more difficult. In addition, rotation of the built-in motor brings contact with a radio frequency connector. This reduces reliability of the antenna.

In conclusion, how to design an antenna to reduce installation complexity of an outdoor terminal and improve an antenna gain is a problem that needs to be resolved urgently.

### SUMMARY

This application provides an antenna apparatus and a communications apparatus, to reduce installation complexity of an outdoor terminal and improve antenna gains.

An embodiment of this application provides an antenna apparatus, including: N antenna ports and M directional polarization antennas, where M is K times 4, N is an integer multiple of 4, N and M are integers greater than 0, and K is an even number greater than 0;
the M directional polarization antennas are evenly distributed on four surfaces of a cube, each surface includes K directional polarization antennas, a polarization direction of K/2 directional polarization antennas on each surface is a first polarization direction, and a polarization direction of other K/2 directional polarization antennas on each surface is a second polarization direction; and
on two neighboring surfaces or two opposing surfaces of the four surfaces, K directional polarization antennas in a same polarization direction are combined into one channel, and are connected to one of the N antenna ports, and each of the N antenna ports is connected to the K directional polarization antennas.

According to the foregoing antenna apparatus, because used antennas are all directional polarization antennas, receiving performance is balanced in all directions, and multi-stream performance is improved. A communications apparatus using the antenna. apparatus may receive a radio frequency signal by using directional polarization antennas in different directions, so that antenna adjustment is reduced and antenna installation complexity is reduced while antenna gains are ensured.

Optionally, the K directional polarization antennas included on each of the four surfaces are superimposed together.

In the foregoing solution, because the K directional polarization antennas included on each surface are superimposed together, a volume of the antenna apparatus can be reduced, antenna installation flexibility can be improved, and antenna installation complexity can be reduced.

Optionally, each of the K directional polarization antennas included on each of the four surfaces is independently distributed on the surface.

In the foregoing solution, because the K directional polarization antennas included on each surface are independent of each other, interference between antennas can be reduced, and antenna gains can be improved.

Optionally, the first polarization direction is −45°, and the second polarization direction is +45°; or the first polarization direction is a horizontal polarization direction, and the second polarization direction is a vertical polarization direction.

An embodiment of this application provides a communications apparatus, including any one of the foregoing antenna apparatuses.

Optionally, the communications apparatus further includes a processor, where
the processor is configured to obtain P signal measurement values that are separately obtained through measurement of each of the M directional polarization antennas within a preset time period, where P is an integer greater than 0; and
when an average value of the P signal measurement values corresponding to one directional polarization antenna in X directional polarization antennas is greater than a sum of an average value of P signal measurement values corresponding to one directional polarization antenna in a transmit antenna currently used by the communications apparatus and a first preset threshold, Y directional polarization antennas with a maximum average value of the P signal measurement values in the M directional polarization antennas are used as a transmit antenna, where
Y is less than or equal to M, and Y is greater than or equal to 1; the X directional polarization antennas are directional polarization antennas that are in the M directional polarization antennas and that are other than the transmit antenna currently used by the communications apparatus; and X is an integer greater than 0.

According to the foregoing solution, a transmit antenna used to transmit a radio frequency signal is adjusted in real time, to obtain optimal uplink performance.

Optionally, the signal measurement value is a reference signal received power RSRP, a received signal strength indicator RSSI, or a signal to interference plus noise ratio SINR

An embodiment of this application provides an antenna apparatus, including M antennas, where the M antennas include two omnidirectional antennas and 2×L directional polarization antennas, and L is an integer greater than 0;
the two omnidirectional antennas are separately distributed on two opposing surfaces of a cube, and each omnidirectional antenna is connected to one antenna port; and
the 2×L directional polarization antennas are evenly distributed on the other two surfaces of the cube, the 2×L directional polarization antennas include L directional polarization antennas in a first polarization direction and L directional polarization antennas in a second polarization direction, the L directional polarization antennas in the first polarization direction are connected to one antenna port after being combined, and the L directional polarization antennas in the second polarization direction are connected to another antenna port after being combined; and
four antenna ports, where one of the four antenna ports is connected to one omnidirectional antenna or is connected to L directional polarization antennas in a same polarization direction.

The foregoing antenna apparatus includes the directional polarization antennas and the omnidirectional antennas. The omnidirectional antennas can receive a radio frequency signal in all directions, and the directional antennas can obtain relatively good antenna gains in a direction, so that antenna adjustment is reduced, antenna installation complexity is reduced, and multi-stream performance can be obtained while antenna gains are ensured.

Optionally, M is 4, and L is 1.

Optionally, antenna reflection plates of the two directional polarization antennas are independent of each other; or the two directional polarization antennas share one antenna reflection plate, and the two directional polarization antennas are separately located on two surfaces of the antenna reflection plate.

Optionally, the 2×L directional polarization antennas all or partially overlay with or do not overlay with the two omnidirectional antennas in space of a vertical dimension.

Optionally, the first polarization direction is −45°, and the second polarization direction is +45°; or the first polarization direction is a horizontal polarization direction, and the second polarization direction is a vertical polarization direction.

An embodiment of this application provides an antenna apparatus, including M antennas, where the M antennas include two omnidirectional antennas and 4×L directional polarization antennas, and L is an integer greater than 0; the 4×L directional polarization antennas include 2×L directional polarization antennas in a first polarization direction and 2×L directional polarization antennas in a second polarization direction; and
the two omnidirectional antennas are separately distributed on two opposing surfaces of a cube, and each omnidirectional antenna is connected to one antenna port; and
the 4×L directional polarization antennas are evenly distributed on four surfaces of the cube, and directional polarization antennas in a same polarization direction in the 4×L directional polarization antennas are connected to one antenna port after being combined; and
four antenna ports, where one of the four antenna ports is connected to one omnidirectional antenna or is connected to 2×L directional polarization antennas in a same polarization direction.

The foregoing antenna apparatus includes the directional polarization antennas and the omnidirectional antennas. The omnidirectional antennas can receive a radio frequency signal in all directions, and each surface of the cube includes a directional antenna. Therefore, relatively good antenna gains can be obtained in a direction by using the directional antenna on each surface, so that antenna adjustment is reduced, antenna installation complexity is reduced, and multi-stream performance can be obtained while antenna gains are ensured.

Optionally, M is 6, and L is 2.

Optionally, the 4×L directional polarization antennas all or partially overlay with or do not overlay with the two omnidirectional antennas in space of a vertical dimension.

Optionally, the first polarization direction is −45°, and the second polarization direction is +45°; or the first polarization direction is a horizontal polarization direction, and the second polarization direction is a vertical polarization direction.

### BRIEF DESCRIPTION OF DRAWINGS

FIG. 1 is a schematic diagram of a scenario applicable to an embodiment of this application;

FIG. 2(a) to FIG. 2(c) are schematic structural diagrams of an antenna apparatus according to an embodiment of this application;

FIG. 3(a) to FIG. 3(c) are schematic structural diagrams of an antenna apparatus according to an embodiment of this application;

FIG. 4(a) to FIG. 4(e) are schematic structural diagrams of an antenna apparatus according to an embodiment of this application;

FIG. 5(a) to FIG. 5(e) are schematic structural diagrams of an antenna apparatus according to an embodiment of this application;

FIG. 6(a) to FIG. 6(c) are schematic structural diagrams of an antenna apparatus according to an embodiment of this application;

FIG. 7 is a schematic diagram of antenna switching according to an embodiment of this application; and

FIG. 8 is a schematic structural diagram of a communications apparatus according to an embodiment of this application.

### DESCRIPTION OF EMBODIMENTS

The following further describes in detail this application with reference to accompanying drawings.

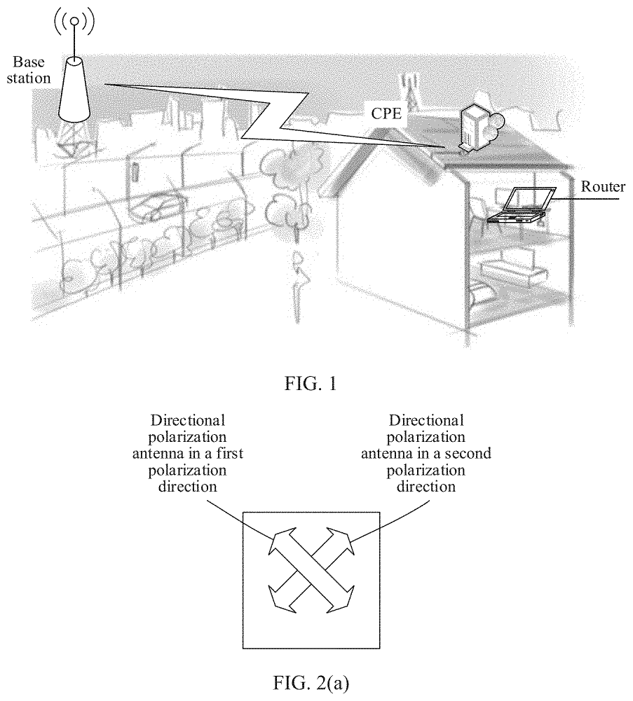

This application may be applied to various communications systems. Specifically, FIG. 1 is a schematic diagram of a scenario applicable to an embodiment of this application. In FIG. 1, an outdoor CPE that is installed on a roof or an external wall converts a received radio frequency signal sent by a base station into a digital signal and accesses a router in a house by using a network cable, or converts a digital signal received over a network cable into a radio frequency signal and sends the radio frequency signal to a base station. The CPE increases coverage of the base station and reduces site deployment costs.

This application provides an antenna apparatus, to reduce installation complexity of a CPE, improve antenna gains, and improve multiple-input multiple-output (Multiple-Input Multiple-Output, MIMO) performance. The following provides detailed descriptions.

In a first possible implementation, the antenna apparatus provided in this embodiment of this application includes N antenna ports and M directional polarization antennas, where M is K times 4, N is an integer multiple of 4, N and M are integers greater than 0, and K is an even number greater than 0.

The M directional polarization antennas are evenly distributed on four surfaces of a cube, each surface includes K directional polarization antennas, a polarization direction of K/2 directional polarization antennas on each surface is a first polarization direction, and a polarization direction of other K/2 directional polarization antennas on each surface is a second polarization direction.

On two neighboring surfaces or two opposing surfaces of the four surfaces, K antennas in a same polarization direction are combined into one channel, and are connected to one of the N antenna ports, and each of the N antenna ports is connected to the K directional polarization antennas.

It should be noted that a specific implementation of the directional polarization antenna is not limited in this embodiment of this application, and examples are not described one by one herein.

It should be noted that the first polarization direction is −45°, and the second polarization direction is +45°; or the first polarization direction is a horizontal polarization direction, and the second polarization direction is a vertical polarization direction.

In this embodiment of this application, how antennas on each surface are specifically arranged is not limited. In a possible implementation, the K directional polarization antennas included on each of the four surfaces are superimposed together.

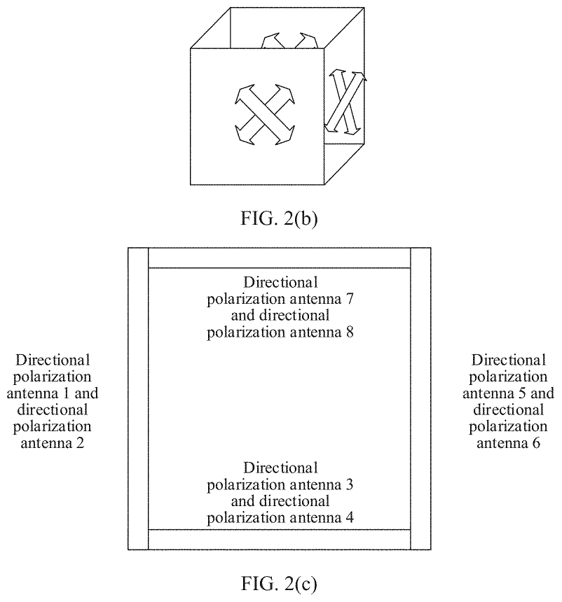

For example, N is equal to 4, M is equal to 8, and K is equal to 2. Two directional polarization antennas included on each surface are superimposed with each other. For details, refer to FIG. 2(a). FIG. 2(a) is a schematic diagram of a directional polarization antenna on any one of four surfaces of a cube. Directional polarization antennas on each surface are superimposed together, and each surface includes one directional polarization antenna in a first polarization direction and one directional polarization antenna in a second polarization direction. FIG. 2(b) is an overall schematic diagram of eight directional polarization antennas. In FIG. 2(b), an antenna port is not shown. Eight directional polarization antennas are evenly distributed on the four surfaces of the cube. On two neighboring surfaces or two opposing surfaces, two antennas in a same polarization direction are combined into one channel and are connected to one antenna port. It should be noted that each directional polarization antenna may be located on an antenna reflection plate, that is, the four surfaces of the cube are formed by four antenna reflection plates. FIG. 2(c) shows a top view of eight directional polarization antennas, and a directional polarization antenna 1 to a directional polarization antenna 8 are distributed on the four surfaces.

For other values of N and M, refer to the foregoing descriptions, and examples are not described one by one herein.

In another possible implementation, each of the K directional polarization antennas included on each of the four surfaces is independently distributed on the surface.

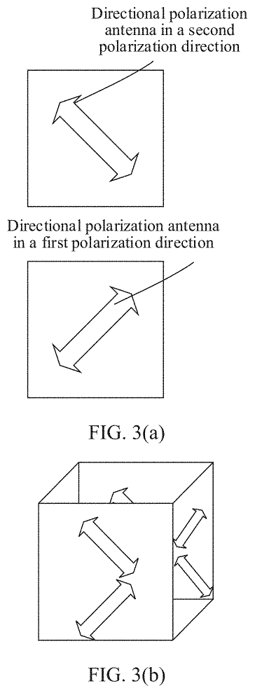

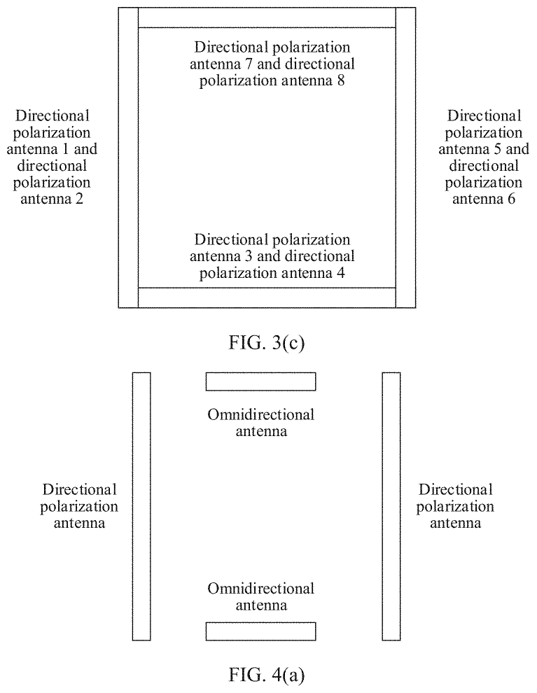

For example, N is equal to 4. M is equal to 8, and K is equal to 2. Each of two directional polarization antennas included on each surface is independently distributed on the surface. For details, refer to FIG. 3(a). FIG. 3(a) is a schematic diagram of a directional polarization antenna on one of four surfaces of a cube. Each of directional polarization antennas on each surface is independently distributed, and each surface includes one directional polarization antenna in a first polarization direction and one directional polarization antenna in a second polarization direction. FIG. 3(b) is an overall schematic diagram of eight directional polarization antennas. In FIG. 3(b), an antenna port is not shown. Eight directional polarization antennas are evenly distributed on the four surfaces of the cube. On two neighboring surfaces or two opposing surfaces, two antennas in a same polarization direction are combined into one channel and are connected to one antenna port. It should be noted that each directional polarization antenna may be located on an antenna reflection plate, that is, the four surfaces of the cube are formed by four antenna reflection plates. FIG. 3(c) shows a top view of eight directional polarization antennas, and a directional polarization antenna 1 to a directional polarization antenna 8 are distributed on the four surfaces.

For other values of N and M, refer to the foregoing descriptions, and examples are not described one by one herein.

An embodiment of this application further provides a communications apparatus. The communications apparatus includes any one of the foregoing antenna apparatuses, and the communications apparatus may be an apparatus such as a CPE. This is not limited in this embodiment of this application.

When receiving a radio frequency signal, the communications apparatus receives the radio frequency signal by using M directional polarization antennas. When sending a radio frequency signal, the communications apparatus sends the radio frequency signal by using Y directional polarization antennas of the M directional polarization antennas, where Y is less than or equal to M.

Further, the communications apparatus further includes a processor. The processor is configured to perform the following actions:
obtaining P signal measurement values that are separately obtained through measurement of each of the NI directional polarization antennas within a preset time period, where P is an integer greater than 0; and
when an average value of the P signal measurement values corresponding to one directional polarization antenna in X directional polarization antennas is greater than a sum of an average value of P signal measurement values corresponding to one directional polarization antenna in a transmit antenna currently used by the communications apparatus and a first preset threshold, or when each of P signal measurement values corresponding to one directional polarization antenna in X directional polarization antennas is greater than a sum of any one of P signal measurement values corresponding to one directional polarization antenna in a transmit antenna currently used by the communications apparatus and a first preset threshold, Y directional polarization antennas with a maximum average value of the P signal measurement values in the NI directional polarization antennas are used as a transmit antenna.

Y is less than or equal to M, and Y is greater than or equal to 1; the X directional polarization antennas are directional polarization antennas that are in the M directional polarization antennas and that are other than the transmit antenna currently used by the communications apparatus; and X is an integer greater than 0.

The communications apparatus may send the radio frequency signal by using the determined transmit antenna.

It should be noted that, in this embodiment of this application, the signal measurement value is a reference signal received power (Reference Signal Receiving Power, RSRP), a received signal strength indicator (Received Signal Strength Indicator, RSSI), or a signal to interference plus noise ratio (Signal to Interference plus Noise Ratio, SINR), How the communications apparatus specifically determines the signal measurement value is not limited in this embodiment of this application. For example, for any directional polarization antenna of the M directional polarization antennas, the communications apparatus may receive, by using the directional polarization antenna, P broadcast signals sent by a base station, and obtain P RSRPs, RSSIs, or SINRs through measurement of the P broadcast signals sent by the base station, to determine P signal measurement values corresponding to the directional polarization antenna.

It should be noted that, in this embodiment of this application, a value of the first preset threshold is a number greater than 0. The first preset threshold may be inversely proportional to a value of P, that is, a larger value of P indicates a smaller value of the first preset threshold.

For example, a quantity of transmit antennas is 1. The communications apparatus obtains 10 signal measurement values that are separately obtained through measurement of each of the M directional polarization antennas within a preset time period; and when an average value of 10 signal measurement values corresponding to one directional polarization antenna in X directional polarization antennas is greater than a sum of an average value of 10 signal measurement values corresponding to a transmit antenna currently used by the communications apparatus and a1, directional polarization antennas with a maximum average value of 10 signal measurement values in the M directional polarization antennas are used as a transmit antenna; or the communications apparatus obtains 20 signal measurement values that are separately obtained through measurement of each of the M directional polarization antennas within a preset time period; and when an average value of 20 signal measurement values corresponding to one directional polarization antenna in X directional polarization antennas is greater than a sum of an average value of 20 signal measurement values corresponding to a transmit antenna currently used by the communications apparatus and a2, directional polarization antennas with a maximum average value of 20 signal measurement values in the M directional polarization antennas are used as a transmit antenna, where a1 is greater than a2.

According to the foregoing antenna apparatus, because the M directional polarization antennas are distributed on four surfaces of a cube, throughputs in all directions can be basically balanced, and multi-stream performance is good. When the communications apparatus uses the foregoing antenna, the communications apparatus can obtain optimal uplink performance by using the foregoing transmit antenna selection method without a need to adjust a physical position of the antenna.

In addition to using all the directional polarization antennas, the antenna apparatus provided in this embodiment of this application may further include an omnidirectional antenna. Specifically, in a second possible implementation, an embodiment of this application provides an antenna apparatus, including: M antennas, where the M antennas include two omnidirectional antennas and 2×L directional polarization antennas, and L is an integer greater than 0; and four antenna ports.

The two omnidirectional antennas are separately distributed on two opposing surfaces of a cube, and each omnidirectional antenna is connected to one antenna port.

The 2×L directional polarization antennas are evenly distributed on the other two surfaces of the cube, the 2×L directional polarization antennas include L directional polarization antennas in a first polarization direction and L directional polarization antennas in a second polarization direction, the L directional polarization antennas in the first polarization direction are connected to one antenna port after being combined, and the L directional polarization antennas in the second polarization direction are connected to another antenna port after being combined. The first polarization direction is −45°, and the second polarization direction is +45°; or the first polarization direction is a horizontal polarization direction, and the second polarization direction is a vertical polarization direction.

One of the four antenna ports is connected to one omnidirectional antenna or is connected to L directional polarization antennas in a same polarization direction.

it should be noted that, in this embodiment of this application, a specific implementation of the omnidirectional antenna is not limited. For example, the omnidirectional antenna may include one element or a plurality of elements, and the plurality of elements may be vertically placed to form an array, or may be separately tilted at a specific angle to form an array. If being tilted, the elements of the two omnidirectional antennas are tilted in opposing directions. For example, the elements of the two omnidirectional antennas are tilted at an angle of +45 degree or −45 degree. Certainly, the omnidirectional antenna may alternatively include another form, and examples are not described one by one herein.

It should be noted that a specific implementation of the directional polarization antenna is not limited in this embodiment of this application, and examples are not described one by one herein.

In this implementation, directional polarization antennas distributed on two opposing surfaces of the cube may share one antenna reflection plate, that is, the 2×L directional polarization antennas are distributed on two surfaces of one antenna reflection plate. Alternatively, directional polarization antennas distributed on two opposing surfaces of the cube may be distributed on different antenna reflection plates.

The 2×L directional polarization antennas all or partially overlay with or do not overlay with the two omnidirectional antennas in space of a vertical dimension.

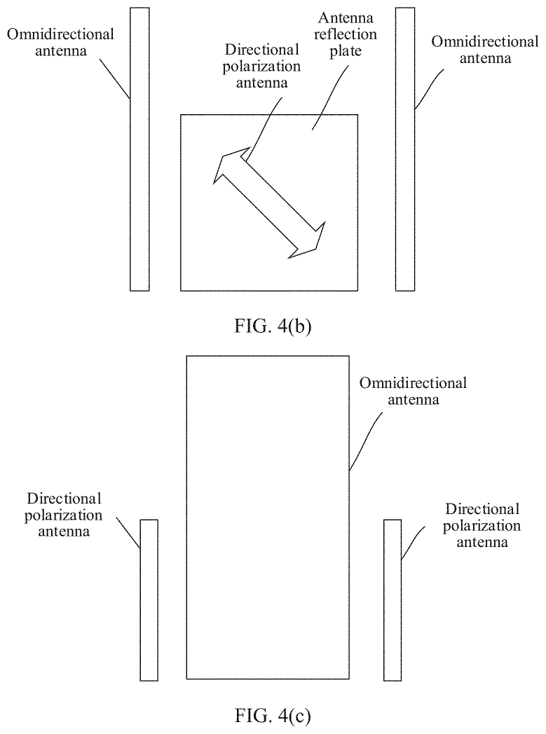

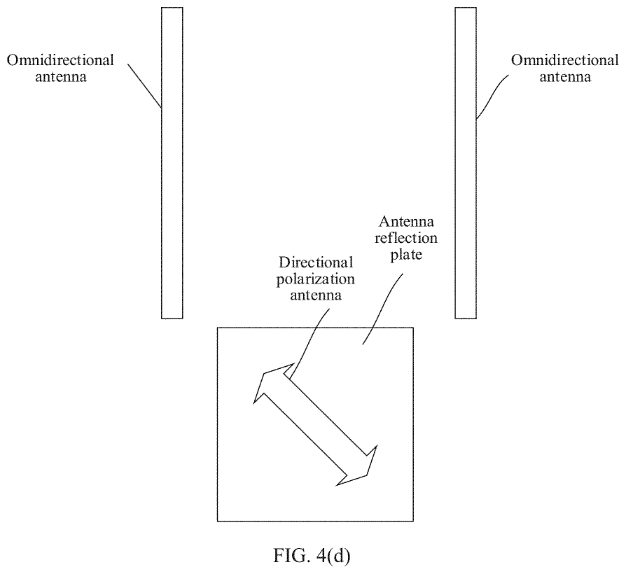

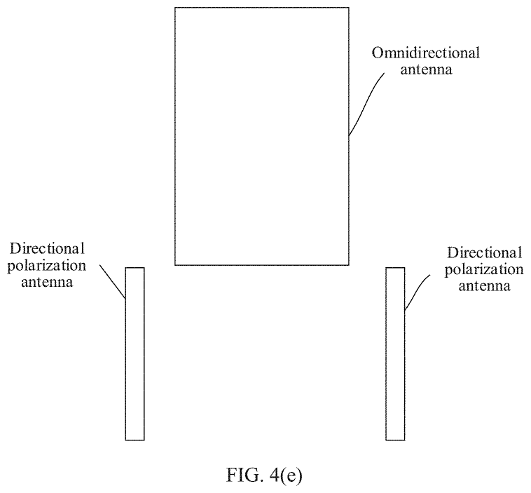

For example, when M is 4, and L is 1, the antenna apparatus includes two omnidirectional antennas and two directional polarization antennas. For details, refer to FIG. 4(a) to FIG, 4(e), FIG. 4(a) is a top view of an antenna apparatus. In FIG. 4(a), two omnidirectional antennas are distributed on two opposing surfaces of a cube, and two directional polarization antennas are distributed on the other two opposing surfaces of the cube. Two directional polarization antennas are distributed on different antenna reflection plates, FIG. 4(b) is a front view of the antenna apparatus. In FIG. 4(b), a directional polarization antenna all overlays with an omnidirectional antenna in space of a vertical dimension. Correspondingly, FIG. 4(c) is a side view of the antenna apparatus.

Certainly, in a vertical dimension, the directional polarization antenna may alternatively be located in another position. For example, FIG. 4(d) is a front view of another antenna apparatus. In FIG. 4(d). the directional polarization antenna and the omnidirectional antenna do not overlay in space of a vertical dimension. Correspondingly, FIG. 4(e) is a side view of the antenna apparatus.

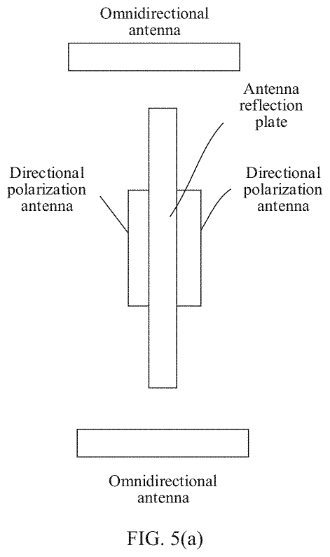

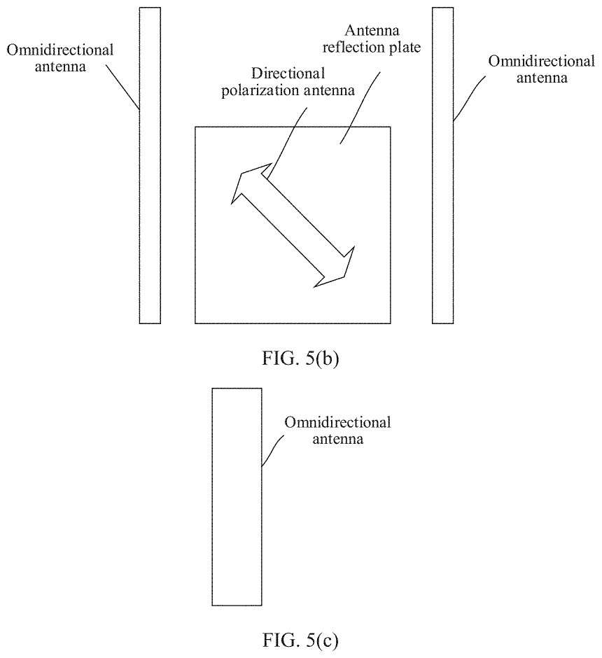

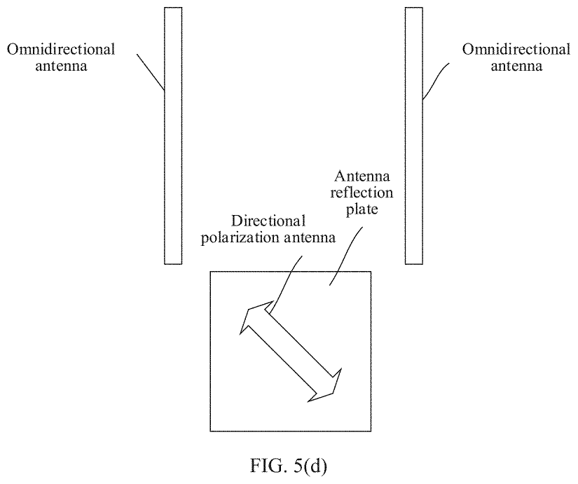

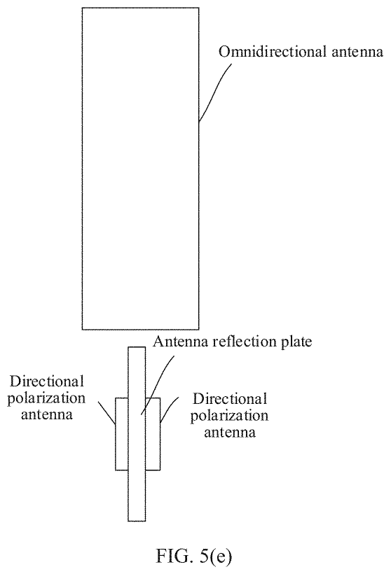

For another example, when M is 4, and L is 1, the antenna apparatus includes two omnidirectional antennas and two directional polarization antennas, and the two directional polarization antennas distributed on two opposing surfaces of the cube share one antenna reflection plate. For details, refer to FIG. 5(a) to FIG. 5(e). FIG. 5(a) is a top view of an antenna apparatus. In FIG. 5(a), two omnidirectional antennas are distributed on two opposing surfaces of a cube, and two directional polarization antennas are distributed on the other two opposing surfaces of the cube, and the two directional polarization antennas share one antenna reflection plate, and are distributed on two surfaces of the antenna reflection plate. FIG. 5(b) is a front view of the antenna apparatus. In FIG. 5(b), a directional polarization antenna all overlays with an omnidirectional antenna in space of a vertical dimension. Correspondingly, FIG. 5(c) is a side view of the antenna apparatus.

Certainly, in a vertical dimension, the directional polarization antenna. may alternatively be located in another position. For example, FIG. 5(d) is a front view of another antenna apparatus. In FIG. 5(d), the directional polarization antenna and the omnidirectional antenna do not overlay in space of a vertical dimension. Correspondingly, FIG. 5(e) is a side view of the antenna apparatus.

For other values of L and M, refer to the foregoing descriptions, and examples are not described one by one herein.

An embodiment of this application further provides a communications apparatus. The communications apparatus includes any one of the foregoing antenna apparatuses, and the communications apparatus may be an apparatus such as a CPE. This is not limited in this embodiment of this application.

When receiving a radio frequency signal, the communications apparatus receives the radio frequency signal by using M antennas. When the communications apparatus sends a radio frequency signal, if the communications apparatus supports only single-antenna transmission, a directional polarization antenna or an omnidirectional antenna is selected as a transmit antenna; or if the communications apparatus supports multi-antenna transmission, two or more antennas are selected from the M antennas as a transmit antenna.

Further, the communications apparatus further includes a processor. The processor is configured to perform the following actions:
obtaining P signal measurement values that are separately obtained through measurement of each directional polarization antenna or omnidirectional antenna of the M antennas within a preset time period, where P is an integer greater than 0; and
when an average value of the P signal measurement values corresponding to one antenna in X antennas is greater than a sum of an average value of P signal measurement values corresponding to one antenna in a transmit antenna currently used by the communications apparatus and a first preset threshold, Y antennas with a maximum average value of the P signal measurement values in the M antennas are used as a transmit antenna.

Y is less than or equal to M, and Y is greater than or equal to 1; the X antennas are antennas that are in the M antennas and that are other than the transmit antenna currently used by the communications apparatus; and X is an integer greater than 0.

The communications apparatus may send the radio frequency signal by using the determined transmit antenna.

In a third possible implementation, an embodiment of this application further provides an antenna apparatus, including: M antennas, where the M antennas include two omnidirectional antennas and 4×L directional polarization antennas, and L is an integer greater than 0; and the 4×L directional polarization antennas include 2×L directional polarization antennas in a first polarization direction is and 2×L directional polarization antennas in a second polarization direction; and four antenna ports, where one of the four antenna ports is connected to one omnidirectional antenna or is connected to 2×L directional polarization antennas in a same polarization direction.

The two omnidirectional antennas are separately distributed on two opposing surfaces of a cube, and each omnidirectional antenna is connected to one antenna port; and the 4×L directional polarization antennas are evenly distributed on four surfaces of the cube, and directional polarization antennas in a same polarization direction in the 4×L directional polarization antennas are connected to one antenna port after being combined.

It should be noted that, in this embodiment of this application, a specific implementation of the omnidirectional antenna is not limited. For example, the omnidirectional antenna may include one element or a plurality of elements, and the plurality of elements may be vertically placed to form an array, or may be separately tilted at a specific angle to form an array. If being tilted, the elements of the two omnidirectional antennas are tilted in opposing directions. For example, the elements of the two omnidirectional antennas are tilted at an angle of +45 degree or −45 degree. Certainly, the omnidirectional antenna may also include another form, and examples are not described one by one herein.

It should be noted that a specific implementation of the directional polarization antenna is not limited in this embodiment of this application, and examples are not described one by one herein.

In this embodiment of this application, the 4×L directional polarization antennas all or partially overlay with or do not overlay with the two omnidirectional antennas in space of a vertical dimension.

In this embodiment of this application, the first polarization direction is −45°, and the second polarization direction is +45°; or the first polarization direction is a horizontal polarization direction, and the second polarization direction is a vertical polarization direction.

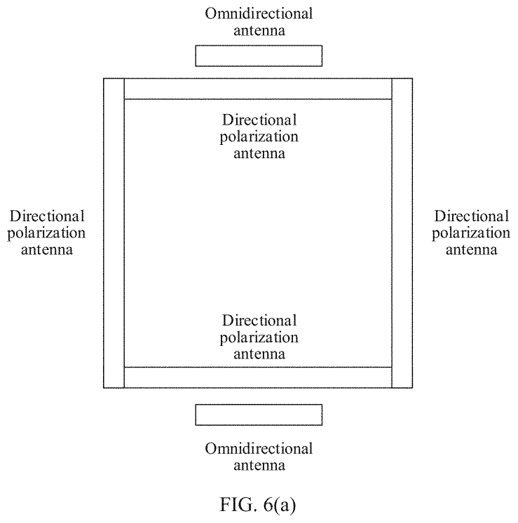

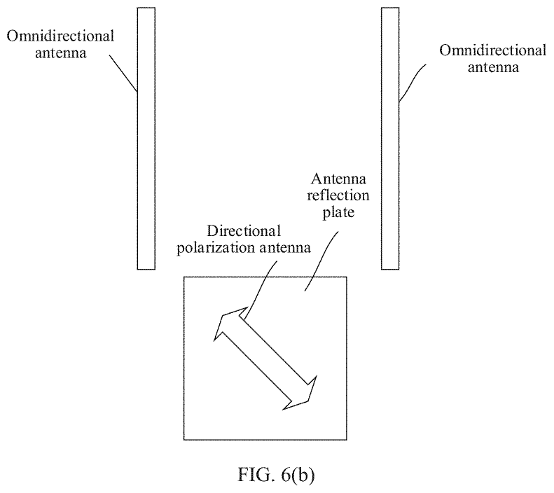

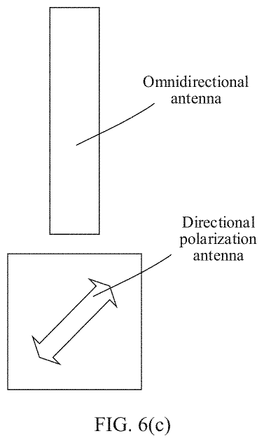

For example, when M is 6, and L is 2, the antenna apparatus includes two omnidirectional antennas and four directional polarization antennas. For details, refer to FIG. 6(a) to FIG. 6(c). FIG. 6(a) is a top view of an antenna apparatus. In FIG. 6(a), two omnidirectional antennas are distributed on two opposing surfaces of a cube, and four directional polarization antennas are evenly distributed on four surfaces of the cube, and directional polarization antennas in a same polarization direction in the four directional polarization antennas are connected to one antenna port (not shown in the figure) after being combined. FIG. 6(b) is a front view of the antenna apparatus, in FIG. 6(b), a directional polarization antenna does not overlay with an omnidirectional antenna in space of a vertical dimension. Correspondingly, FIG. 6(c) is a side view of the antenna apparatus.

Certainly, in a vertical dimension, the directional polarization antenna may alternatively be located in another position. For example, the directional polarization antenna all or partially overlays with the omnidirectional antenna in space of a vertical dimension, and details are not described herein again.

For other values of L and M, refer to the foregoing descriptions, and examples are not described one by one herein.

An embodiment of this application further provides a communications apparatus. The communications apparatus includes any one of the foregoing antenna apparatuses, and the communications apparatus may be an apparatus such as a CPE. This is not limited in this embodiment of this application.

When receiving a radio frequency signal, the communications apparatus receives the radio frequency signal by using M antennas. When the communications apparatus sends a radio frequency signal, if the communications apparatus supports only single-antenna transmission, a directional polarization antenna or an omnidirectional antenna is selected as a transmit antenna; or if the communications apparatus supports multi-antenna transmission, two or more antennas are selected from the M antennas as a transmit antenna.

Further, the communications apparatus further includes a processor. The processor is configured to perform the following actions:
obtaining P signal measurement values that are separately obtained through measurement of each directional polarization antenna or omnidirectional antenna of the M antennas within a preset time period, where P is an integer greater than 0; and
when an average value of the P signal measurement values corresponding to one antenna in X antennas is greater than a sum of an average value of P signal measurement values corresponding to one antenna in a transmit antenna currently used by the communications apparatus and a first preset threshold; Y antennas with a maximum average value of the P signal measurement values in the M antennas are used as a transmit antenna.

Y is less than or equal to M, and Y is greater than or equal to 1; the X antennas are antennas in the M antennas other than the transmit antenna currently used by the communications apparatus; and X is an integer greater than 0.

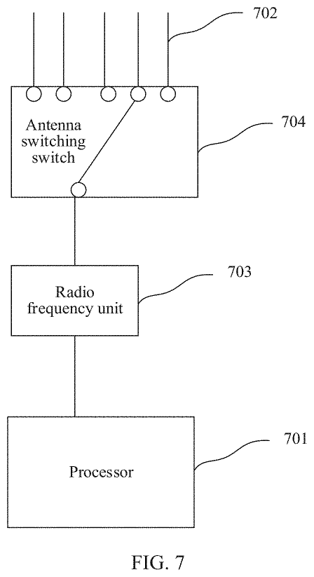

It should be noted that, in this embodiment of this application, a processor in any one of the foregoing communications apparatuses may be a baseband processor, hereinafter referred to as a processor. After determining the transmit antenna, the processor sends a switching instruction to an antenna switching switch, and the switching instruction instructs the antenna switching switch to select and connect a link of the determined transmit antenna. After the antenna switching switch selects and connects, based on the switching instruction, the link of the transmit antenna determined by the processor, the processor may transmit an uplink signal to a radio frequency unit, and then the radio frequency unit transmits the uplink signal by using the selected and connected transmit antenna. For details, refer to FIG. 7. In FIG. 7, there are units such as a radio frequency unit 703 and an antenna switching switch 704 between a processor 701 and an antenna apparatus 702. A specific structure of the foregoing units is not limited in this embodiment of this application, and details are not described herein again. The processor 701 instructs, by using a switching instruction, the antenna switching switch 704 to select at least one antenna from the antenna apparatus 702 as a transmit antenna, so that the radio frequency unit 703 may send an uplink signal by using the selected and connected transmit antenna.

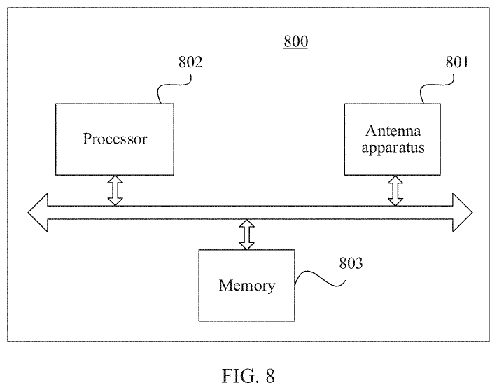

FIG. 8 is a schematic structural diagram of a communications apparatus according to an embodiment of this application.

The communications apparatus 800 includes an antenna apparatus 801, the antenna apparatus 801 may be any one of the foregoing antenna apparatuses, and the communications apparatus 800 may be an apparatus such as a CPE. This is not limited in this embodiment of this application.

The communications apparatus 800 further includes a processor 802 and a memory 803.

The memory 803 may be configured to store a program instruction. The processor 802 invokes the program instruction stored in the memory 803, to perform one or more steps of the antenna apparatus or an optional implementation in the foregoing method embodiments, so that the communications apparatus 800 implements a function in the foregoing methods.

The processor 802 is configured to perform the following actions:
obtaining P signal measurement values that are separately obtained through measurement of each of the M directional polarization antennas within a preset time period, where P is an integer greater than 0; and
when an average value of the P signal measurement values corresponding to one directional polarization antenna in X directional polarization antennas is greater than a sum of an average value of P signal measurement values corresponding to one directional polarization antenna in a transmit antenna currently used by the communications apparatus and a first preset threshold, or when each of P signal measurement values corresponding to one directional polarization antenna in X directional polarization antennas is greater than a sum of any one of P signal measurement values corresponding to one directional polarization antenna in a transmit antenna currently used by the communications apparatus and a first preset threshold, Y directional polarization antennas with a maximum average value of the P signal measurement values in the M directional polarization antennas are used as a transmit antenna.

Y is less than or equal to M, and Y is greater than or equal to 1; the X directional polarization antennas are directional polarization antennas that are in the M directional polarization antennas and that are other than the transmit antenna currently used by the communications apparatus; and X is an integer greater than 0.

Clearly, a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. An antenna apparatus, comprising: N antenna ports and M directional polarization antennas, wherein M is K times 4, N is an integer multiple of 4, N and M are integers greater than 0, and K is an even number greater than 0;
the M directional polarization antennas are evenly distributed on four surfaces of a cube, each surface comprises K directional polarization antennas, a polarization direction of K/2 directional polarization antennas on each surface is a first polarization direction, and a polarization direction of other K/2 directional polarization antennas on each surface is a second polarization direction; and
on two neighboring surfaces or two opposing surfaces of the four surfaces, K directional polarization antennas in a same polarization direction are combined into one channel, and are connected to one of the N antenna ports, and each of the N antenna ports is connected to the K directional polarization antennas.

2. The antenna apparatus according to claim 1, wherein the K directional polarization antennas comprised on each of the four surfaces are superimposed together.

3. The antenna apparatus according to claim 1, wherein each of the K directional polarization antennas comprised on each of the four surfaces is independently distributed on the surface.

4. The antenna apparatus according to claim 1, wherein the first polarization direction is −45°, and the second polarization direction is +45°; or the first polarization direction is a horizontal polarization direction, and the second polarization direction is a vertical polarization direction.

5. The antenna apparatus according to claim 2, wherein the first polarization direction is −45°, and the second polarization direction is +45°; or the first polarization direction is a horizontal polarization direction, and the second polarization direction is a vertical polarization direction.

6. The antenna apparatus according to claim 3, wherein the first polarization direction is −45°, and the second polarization direction is +45°; or the first polarization direction is a horizontal polarization direction, and the second polarization direction is a vertical polarization direction.

7. An antenna apparatus, comprising M antennas, wherein the M antennas comprise two omnidirectional antennas and 2×L directional polarization antennas, and L is an integer greater than 0;
the two omnidirectional antennas are separately distributed on two opposing surfaces of a cube, and each omnidirectional antenna is connected to one antenna port; and
the 2×L directional polarization antennas are evenly distributed on the other two surfaces of the cube, the 2×L directional polarization antennas comprise L directional polarization antennas in a first polarization direction and L directional polarization antennas in a second polarization direction, the L directional polarization antennas in the first polarization direction are connected to one antenna port after being combined, and the L directional polarization antennas in the second polarization direction are connected to another antenna port after being combined; and
four antenna ports, wherein one of the four antenna ports is connected to one omnidirectional antenna or is connected to L directional polarization antennas in a same polarization direction.

8. The antenna apparatus according to claim 7, wherein M is 4, and L is 1.

9. The antenna apparatus according to claim 8, wherein antenna reflection plates of the 2×L directional polarization antennas are independent of each other; or the 2×L directional polarization antennas share one antenna reflection plate, and the 2×L directional polarization antennas are separately located on two surfaces of the antenna reflection plate.

10. The antenna apparatus according to claim 7, wherein the 2×L directional polarization antennas all or partially overlay with or do not overlay with the two omnidirectional antennas in space of a vertical dimension.

11. The antenna apparatus according to claim 8, wherein the 2×L directional polarization antennas all or partially overlay with or do not overlay with the two omnidirectional antennas in space of a vertical dimension.

12. The antenna apparatus according to claim 9, wherein the 2×L directional polarization antennas all or partially overlay with or do not overlay with the two omnidirectional antennas in space of a vertical dimension.

13. The antenna apparatus according to claim 7, wherein the first polarization direction is −45°, and the second polarization direction is +45°; or the first polarization direction is a horizontal polarization direction, and the second polarization direction is a vertical polarization direction.

14. An antenna apparatus. comprising M antennas, wherein the M antennas comprise two omnidirectional antennas and 4×L directional polarization antennas, and L is an integer greater than 0; the 4×L directional polarization antennas comprise 2×L directional polarization antennas in a first polarization direction and 2×L directional polarization antennas in a second polarization direction; and
the two omnidirectional antennas are separately distributed on two opposing surfaces of a cube, and each omnidirectional antenna is connected to one antenna port; and
the 4×L directional polarization antennas are evenly distributed on four surfaces of the cube, and directional polarization antennas in a same polarization direction in the 4×L directional polarization antennas are connected to one antenna port after being combined; and
four antenna ports, wherein one of the four antenna ports is connected to one omnidirectional antenna or is connected to 2×L directional polarization antennas in a same polarization direction.

15. The antenna apparatus according to claim 14, wherein M is 6, and L is 2.

16. The antenna apparatus according to claim 14, wherein the 4×L directional polarization antennas all or partially overlay with or do not overlay with the two omnidirectional antennas in space of a vertical dimension.

17. The antenna apparatus according to claim 15, wherein the 4×L directional polarization antennas all or partially overlay with or do not overlay with the two omnidirectional antennas in space of a vertical dimension.

18. The antenna apparatus according to claim 14, wherein the first polarization direction is −45°, and the second polarization direction is +45°; or the first polarization direction is a horizontal polarization direction, and the second polarization direction is a vertical polarization direction.

19. The antenna apparatus according to claim 15, wherein the first polarization direction is −45°, and the second polarization direction is +45°; or the first polarization direction is a horizontal polarization direction, and the second polarization direction is a vertical polarization direction.

20. The antenna apparatus according to claim 16, wherein the first polarization direction is −45°, and the second polarization direction is +45°; or the first polarization direction is a horizontal polarization direction, and the second polarization direction is a vertical polarization direction.
